(19) United States
(12) Patent Application Publication
(10) Pub. No.: US 2017/0284361 A1
(43) Pub. Date: Oct. 5, 2017

(54) Artificially expanding the tide range of a tidal barrage

(71) Applicant: Daniel Robert Watkins, Campbell, CA (US)

(72) Inventor: Daniel Robert Watkins, Campbell, CA (US)

(21) Appl. No.: 14/999,077

(22) Filed: Mar. 29, 2016

(51) Int. Cl. F03B 13/26; F03B 13/14; H02K 7/18

(52) U.S. Cl. CPC F03B 13/268; H02K 7/1823; F03B 13/147

(57) ABSTRACT

Some geographies have tide ranges above 15 yards, but most do not. The wider the tide range, the more hydroelectric power can be generated per cycle of low tide to high tide and then high tide to low tide, using a tidal barrage. Methods of raising the high tide above the measured level to fill the storage ponds to an even higher level and a method to empty the storage ponds to a lower than low tide level, provide means to expand the tide range significantly, enabling many more planet geographies to have economically feasible hydroelectric power.

### BACKGROUND OF THE INVENTION

The invention pertains to expanding of tide range of tidal barrages, using enhancements to water storage ponds, methods to raise above high tide levels water that fills the ponds, a method to lower the lowest point at which water can be used in the ponds, and controlling the system to have maximum head available always for water flow use in hydroelectric generation.

### DESCRIPTION

### 1. Field of the Invention

The invention relates to the field of expanding the tide range of a tidal barrage while maximizing the head available, for hydroelectric generation.

### 2. Prior Art

Regarding filling the storage pond above the high tide level, some systems with turbines use excess energy in the grid to power the turbines in reverse which will pump water in to the storage pond at high tide to raise the level, typically a few feet. The downside is this costs energy to pump this water and the amount of feet added to the pond level is limited.

### SUMMARY OF THE INVENTION

Hydroelectric power using tidal barrages has been capping out, as there are a limited number of planet geographies where these are economically feasible. The invention enables many more geographies with lesser tide ranges, even along the California coast, to use tidal barrages in an economically feasible way.

The expanded tide range tidal barrage with maximum head system features:
Minimum power is needed to run the system:
   siphoning is used (consumes no power) to expel the Hydroelectric Generator (HEG) water output where typically only at start-up is there a need to pre-load the siphon pipe using a water pump
   natural tides are used to fill the main & flush water storage ponds
   low energy gate open/close methods are used
   electronic controllers are used (a web based server app could control the entire flow).
Control is automatic.
   Tidal waves are more predicable than wind & solar and thus predictions on high tide and low tide are accurate and can be embedded in the App or taken from an online web site, for configuring the system.
   A siphon sensor that monitors flow, provides input to the controller.
   A HEG sensor that monitors flow, provides input to the controller.
   The sluice up and down movement in the increments needed, the controller handles, in part based on the configured expected high tide & low tide times & levels, but also on pond water level sensors and input to sluice water level sensors.
   The FWI to HEG flex pipe delta straightness, the controller handles.
   The shore hole water level sensors, provides input to the controller.
   Optional electrical storage, such as Tesla battery systems, are easily integrated and controlled, as the electricity the system generates in predicable.
   The solution scales from supporting a single user, such as a residential home, up to a small city. The sizes of the storage & flush ponds change, the size of the HEG with its inputs and outputs change. Site geological modifications to accommodate the solution may be minor. The ponds can be jutted out to sea in large part, if so needed, limiting the use of shoreline.
   The solution scales to the geography's landscape along the sea shore.
   The maximum head is available for HEG always (provides highest efficiency).
   The system is eco-friendly, innocuous to fish and largely passive. There are water filters on the HEG input.
With the cascaded HEG at the siphon output, the power generation is essentially doubled.

### BRIEF DESCRIPTION OF THE DRAWINGS

FIG. 1 is logic block diagrams of two side views, of the maximizing head of tidal barrage and high tide plus level features.

FIG. 2 is logic block diagrams of a front view and a top view, of the maximizing head of tidal barrage and high tide plus level features.

FIG. 3 is a logic block diagram of high tide plus level.

### DETAILED DESCRIPTION OF THE PRESENT INVENTION

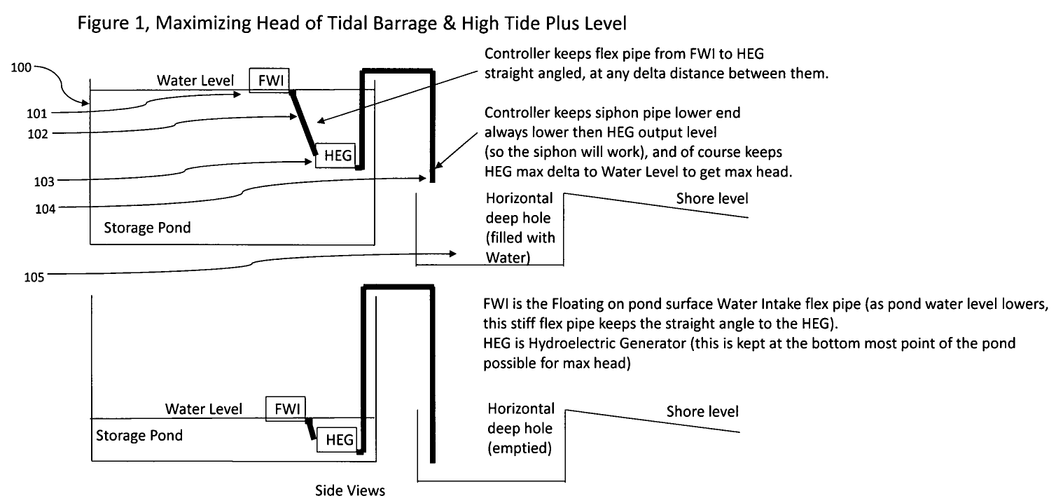

FIG. 1, illustrates two side view examples, of the tidal barrage. The embodiments described herein are not limited to this example. The water storage pond 100 has a flat bottom, sides and a water level that reflects the high tide mark plus more height (referred to has High Tide Plus Level, or HTPL), provided by system features. The FWI (Floating on the pond surface Water Intake flex pipe) 101 provides the water to the flex pipe 102 that provides the water to the HEG (Hydroelectric Generator) 103 input. Siphon pipe 104 takes the HEG output water and siphons it out of the pond. The shore hole 105 is used to provide below low tide level to the siphon so the pond can be even deeper with water (which then provides more tidal range).

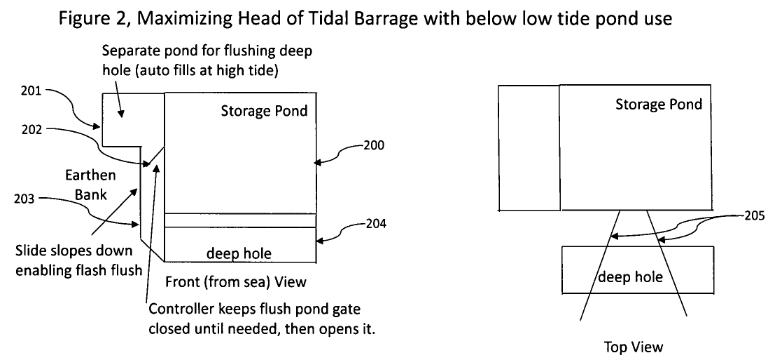

FIG. 2, illustrates a front view and a top view example, of the tidal barrage. The embodiments described herein are not limited to this example. The flushing pond 201 provides water storage for use in flushing shore holes. The flushing pond gate 202 is closed to fill the flushing pond with higher tide water and is opened when it is needed to flush the shore holes. The slide 203 guides the flushing water down to the shore holes. The shore holes 204 are always where the siphon pipe output goes. The walls 205 jut out to sea to channel with more force the incoming water to raise the high tide level even higher to fill the pond even higher.

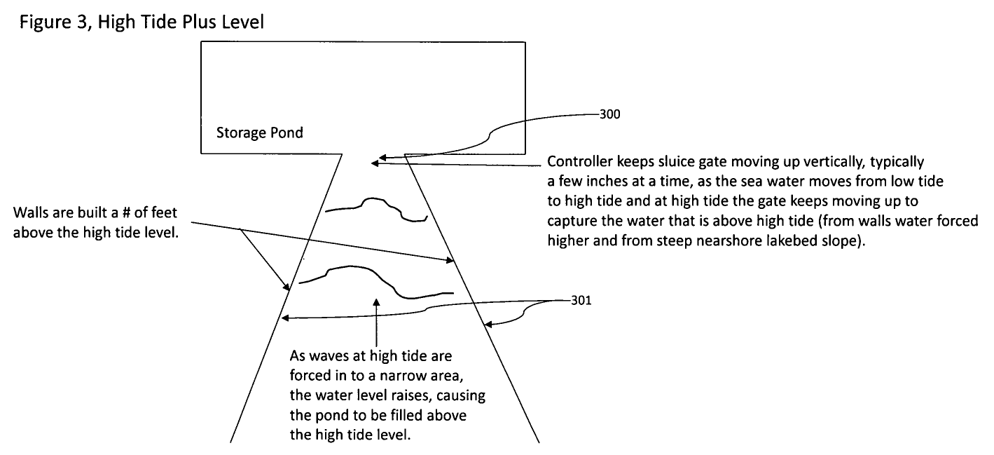

FIG. 3, illustrates a top view example, of the tidal barrage. The embodiments described herein are not limited to this example. The sluice gate 300 is where the tide water fills the pond and is controlled to fill the pond to the highest level possible.

The following is a use description.
Up to high tide time, the open sluice allows the storage pond to fill up.
   A method to fill the pond above the high tide elevation is added (called high tide plus level or HTPL), using a wall added to each side of the sluice, where each wall juts out at an angle (between 0 and 90 degrees) to the sea, enabling the tide forces constrained within the two walls narrowing to the sluice, to force the tide water above the high tide level in to the storage pond.
   A method to modify the nearshore lakebed slope to be always steep causing approaching waves to rise quickly to a height dependent on water depth, and then plunge quickly is added. An example design is the stone revetment. These above high tide waves would move water to the pond, above the high tide mark, where the water is held in the pond by a vertically gradually moving up sluice gate.
   At peak high tide, with the maximum HTPL reached, the sluice is closed.
   The sea tide will get lower. When there is adequate head across the pond & sea the hydroelectric generator runs. When the sea is near low tide, where there is no longer adequate head across the pond & sea, the generator typically turns off.
   But a method to empty the pond (which is built to have a floor below the low tide mark) beyond the low water mark (called low tide plus level or LTPL) is added, using a reserved elevated side mini-pond (that like a town's water tower) has pressurized water that clears out the low tide shore to below the low tide level (a large deep hole horizontal to the shore is water sprayed with an artificial tidal wave, to remove the water). At low tide, when the minimum LTPL is reached, the sluice is opened.
   These introduced methods widen the available level difference, increasing hydroelectric generation per tide cycle.
   The water output on the hydroelectric generator (HEG) can be syphoned out, as the HEG is always above the sea & deep hole water levels, nearly eliminating any electric energy consumption with this system, accept for a small electric pump to pre-fill the syphon.
   To get the maximum water flow, the HEG intake is attached to a flex pipe that floats on the top of the pond.
   For example, San Francisco shores have about 5′ of tide range cycling about every 12 hours. If these methods double this range, it approximately doubles the output of the HEG, making tidal barrages economically viable. With a one acre storage pond (with clay packed bottom and sides), a ¼ acre 5′ deep hole horizontal to the shore (with clay packed bottom and sides), and a pair of 10′ high walls narrowing to the sluice, a control system to keep the sluice during filling at max high possible preventing flow back to the sea, a doubling of tidal range could occur. The HEG does full 10′ range generation every 12 hours, running for 6 hours, emptying about 10 acre feet (10×325851 gallons), for 9051 GPM. So, (Head in feet×GPM)/12=wattage generated. So, 5′ (average)×9051/12=3771 watts. Over the course of a day, this would be 12×3771 watts or 45252 watt-hours or 45 kWh. California has 6,744 kWh per residential customer consumption per year. So this 1 acre tidal barrage could support about 7 homes, displacing $7728 in energy bills per year. With a second HEG used at the siphon output, the 1 acre tidal barrage could support 14 homes, displacing $15,456 in energy bills per year.
   Note the acre pond does not need to be square and can jut out in the water which is especially more easy if the water is shallow, than take up shoreline feet, with the optional large deep hole horizontal still being on shore.
   Of course the example can scale to more or less acre-feet of pond, supporting more or less energy generation. With 140 homes saving $154,560/year using a 10 acre tidal barrage, the payback of the system would be <5 years. Further, there is now battery storage systems, such as Tesla's, that can store the electrical energy generated for use when it is between low tide and high tide, enabling a 24/7 energy use system.

1. A tidal barrage means comprising:
(a) A storage pond, with a sluice for filling and emptying the storage pond.
(b) A hydroelectric generator that uses the level of water in the storage pond as the upper point of the head.
(c) A siphon that removes the hydroelectric generator water output to outside the storage pond.

2. A tidal barrage means according to claim 1 wherein one or more vertical walls are angled and jutted out in the sea such that the sea water is constrained in to the sluice with higher force, enabling higher than high tide levels of water to be filling the storage pond.

3. A tidal barrage means according to claim 1 wherein one or more nearshore lakebed slopes are modified to be always steep causing approaching waves to rise quickly to a height dependent on water depth, enabling higher than high tide levels of water to be filling the storage pond.

4. A tidal barrage means according to claim 1 wherein one or more shore holes can have low tide water levels lowered using flush means, enabling lower than low tide levels of water to be emptied from the storage pond utilizing one or more siphons.

5. A tidal barrage means according to claim 4 wherein the flush means is one or more separate flush storage ponds that fill up with a tide and where one or more controllers direct the movement of the flush storage pond gate, which when open flushes one or more shore holes to have lower then low tide water levels.

6. A tidal barrage means according to claim 5 wherein the maximum head for highest generator output supportable includes at the lowest point, just above the water level of shore holes after flush has been done or higher, the lowest part of the siphon.

7. A tidal barrage means according to claim 2 wherein one or more controllers direct the movement of the sluice to enable capture of the highest water level the pond can.

8. A tidal barrage means according to claim 3 wherein one or more controllers direct the movement of the sluice to enable capture of the highest water level the pond can.

9. A tidal barrage means according to claim 1 wherein one or more controllers direct the movement of the hydroelectric generator relative to the storage pond floating water intake pipe to enable the maximum head for highest generator output supportable.

10. A tidal barrage means according to claim 9 wherein the flex pipe between the storage pond floating water intake pipe and the hydroelectric generator is kept adequately straight to allow the water flow to the hydroelectric generator to reflect the head available.

11. A tidal barrage means according to claim 1 wherein one or more controllers direct the movement of the hydroelectric generator in tandem with the lowest part of the siphon to enable a working siphon.

12. A tidal barrage means according to claim 1 wherein on the lowest part of the siphon, another HEG is added where this HEG output is flowing at this level.

13. A tidal barrage means according to claim 12 wherein a first HEG output goes to a siphon over a wall that drives a second HEG, where the second HEG output goes to a siphon over another wall that drives a third HEG and so on, where the use of siphons generates more overall head, generating more electricity, than if no siphons were used where just the highest and lowest water levels would determine the head.
